(19) United States
(12) Patent Application Publication
(10) Pub. No.: US 2013/0254706 A1
(43) Pub. Date: Sep. 26, 2013

(54) INFORMATION AND ACTION BAR FOR A USER INTERFACE

(71) Applicants: Brian J. Gibbons, Phoenixville, PA (US); Justin Szczurowski, Schwenksville, PA (US)

(72) Inventors: Brian J. Gibbons, Phoenixville, PA (US); Justin Szczurowski, Schwenksville, PA (US)

(73) Assignee: eBay Inc., San Jose, CA (US)

(21) Appl. No.: 13/608,200

(22) Filed: Sep. 10, 2012

Related U.S. Application Data
(60) Provisional application No. 61/613,203, filed on Mar. 20, 2012.

(51) Int. Cl. G06F 3/048

(52) U.S. Cl. 715/784; 715/781; 715/790

(57) ABSTRACT

Disclosed in some examples is a method including presenting an interface to a user; displaying a first action element in the interface; detecting a user navigation which renders the first action element not visible in the interface; responsive to the detection, displaying a window within the interface, the window comprising an information element and a second action element. The method may include detecting a user action associated with the action element and performing an action associated with the action element.

### CLAIM OF PRIORITY

This patent application claims the benefit of priority, under 35 U.S.C. Section 119(e), to Gibbons et al, U.S. Provisional Patent Application Ser. No. 61/613,203, entitled “Information and Action Bar” filed on Mar. 20, 2012 (Attorney Docket No. 2043.A71PRV), which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright eBay, Inc., All Rights Reserved.

### BACKGROUND

Interfaces such as web-pages now include an abundance of information which is presented to a user. For example, information presented to a consumer can include detailed descriptions of products, related items, suggested items, customer reviews, recently viewed items, and the like. As the information presented to the consumer grows, it makes it more difficult to keep important information in front of the consumer because as the amount of information increases, the size of the page becomes larger. Consumers may get “lost” in the amount of information. This may cause a lost sale as the consumer may forget what product they are interested in, or have difficulty finding the actionable items of a page in order to initiate a purchase. The action items may include items such as adding the product to the cart, a wish list, a baby-list, a wedding list, or the like.

### SUMMARY

In an example embodiment, a method comprises presenting an interface to a user; displaying a first action element in the interface; detecting a user navigation which renders the first action element not visible in the interface; and, responsive to the detection, displaying a window within the interface, the window comprising an information element and a second action element.

In an example embodiment, a system comprises at least one module, executing on one or more computer processors, to present an interface to a user; display a first action element in the interface; detect a user navigation which renders the first action element not visible in the interface; and responsive to the detection, display a window within the interface, the window comprising an information element and a second action element.

Another example embodiment may comprise a machine readable medium, including instructions, which when performed by a machine, causes the machine to perform the operations of presenting an interface to a user; displaying a first action element in the interface; detecting a user navigation, which renders the first action element not visible in the interface; and responsive to the detection, displaying a window within the interface, the window comprising an information element and a second action element.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a screenshot showing an example website page according to some examples of the present disclosure.

FIG. 2 is another screenshot showing an example website page according to some examples of the present disclosure.

FIG. 3 is a screenshot showing an example of the information and action bar according to some examples of the present disclosure.

FIG. 4 is a flowchart of a method of presenting an information and action bar according to some examples of the present disclosure.

FIG. 5 is a flowchart of a method of carrying out an action on an information and action bar according to some examples of the present disclosure.

FIG. 6 is a schematic of a system of displaying an information and action bar according to some examples of the present disclosure.

FIG. 7 is a schematic of a machine according to some examples of the present disclosure.

FIG. 8 is a screen shot showing an example website page according to some examples of the present disclosure.

FIG. 9 is another screen shot showing an example website page according to some examples of the present disclosure.

FIG. 10 is a screenshot showing an example of the information an action bar according to some examples of the present disclosure.

FIG. 11 is a flowchart of a method according to some examples of the present disclosure.

### DETAILED DESCRIPTION

Disclosed in some examples are methods, systems, and machine readable media which present to the user an information and action “bar” (also termed a “window” in this specification) is displayed in response to the user navigating to, or past, a predetermined trigger point on a web-page. The information and action bar may be a graphical visual element displayed in the user's browser as overlaid on top of, and separate from the webpage. The information and action bar may be displayed on the screen when the user navigates to, or past, the predetermined trigger point and in some examples, may disappear when the user navigates back before the trigger point. The bar or window may be of any appropriate shape or outline. The bar may be rectangular in some embodiments, but other shapes are possible. The information and action bar may include important information and also one or more action elements which may allow the user to initiate one or more actions (e.g., adding the item to the cart). The information displayed may include any subset of the information displayed on the page and may include text, graphics, animations, or any other aspect of the page.

Examples of information may include a product title, a short description, a price, a picture of the product, a merchant's logo, or the like. Certain additional features that may not exist on the page may also be included. Examples of these additional features may include cross-sells (i.e. related products), social media info, advertisements or general widgets of a standard e-commerce offering. Action elements may be any user interactive element which allows the user to act upon the product information in some way. Example action elements include buttons which allow users to navigate to other portions of the page (e.g., a “click to return to the top of the page” button), make purchasing decisions (e.g., add-to-cart, buy now with paypal), adding the item to wish lists, layaway, registries (e.g., baby registry, wedding shower registry, or the like), links to send a description of the item to a friend, or the like. In some examples, the action element may be a subset of the action elements which already exist on the website.

Upon a user interaction with the action elements, the action elements may trigger the execution of one or more scripts. In some examples, these scripts may carry out the desired functions of the action element (e.g., adding the item to the consumer's digital shopping cart). In other examples, the scripts may simulate a user interaction with an associated action element on the web-page, such that the script causes execution of the commands and scripts associated with the web-page action element to which it is associated. For example, rather than creating duplicate action items, one for the web-page and another for the information and action bar, triggering an action element in the information and action bar may execute a script (e.g., JavaScript) which may simulate a click or other action on the action element in the main web-page. Thus the user's click or other action which triggers an action element on the information and action bar may be “tunneled” or linked to the action element on the main web page. This may allow for easier implementation of the information and action bar, as well as ensuring that no events on a given web page element are missed.

As already noted the display of the information and action bar may be triggered upon the user navigating to or past a predetermined trigger point on a web-page. The term “web-page” in this specification should be interpreted to include any electronic interface, screen or monitor on which information or action elements can be presented. Such interfaces can include for example user terminal screens, monitor screens, or touch screens on mobile devices, such as “smart phones” for example. The term “bar” is also intended to cover a window or planar area.

Further, the term “navigation” in this specification should be taken to include, for example, movement of a screen cursor or pointer on an interface. The movement or placement of a finger on a touch screen should also be included within the ambit of this term. Scrolling actions, or moving or re-sizing (for example, minimizing/maximizing) a screen or window, are also included within the meaning of the term. Other types of navigation are possible, for example by keyboard entry, by voice commands, and so forth. For example, if the user scrolls past an action element (e.g., an add-to-cart action element which adds the item to a user's digital shopping cart), the information and action bar may be displayed (e.g., with that action element). In another example, a user may resize a screen so that an action item or predetermined trigger point “disappears” from view. In a similar manner, the border of a moving or re-sized screen may pass a predetermined trigger point. These example user navigations may trigger the information and action bar to be displayed. In this way a retailer may always keep certain action elements “on screen” by utilizing the information and action bar. For example, if the online merchant wishes to keep the add-to-cart button visible, the merchant sets up the information and action bar to trigger once the user scrolls past the add-to-cart button of the web-page. Additionally, in some examples, the information and action bar may remain visible regardless of where in the page the user navigates to, or how the navigation as defined above occurs in the interface. In other examples, the information and action bar may remain visible only until the user navigates to a place in the page before the trigger point, at which time the information and action bar may then disappear. Thus, for example, when the user navigates to an area of the page where the “add-to-cart” button on the web-page is again visible, the information and action bar may then disappear.

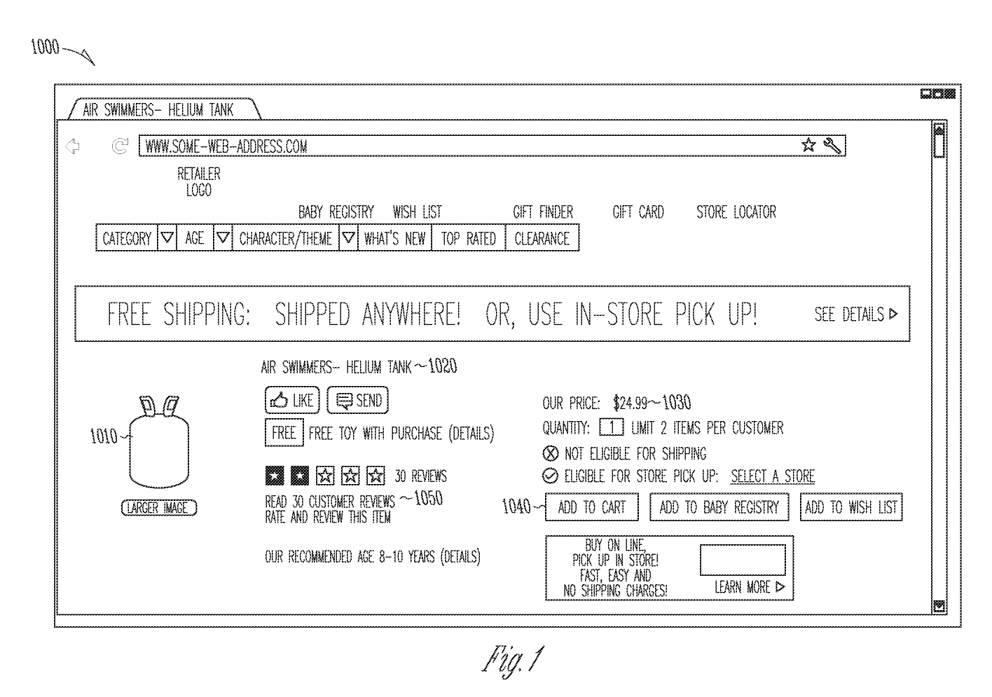

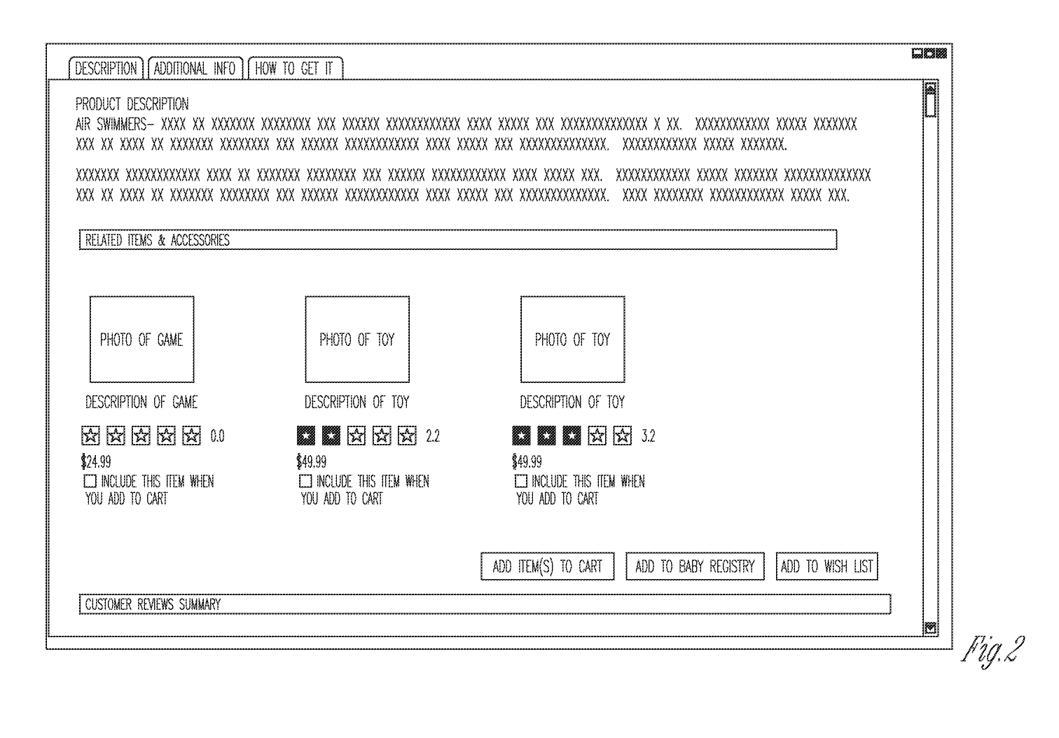

Turning now to FIG. 1, an example web-page 1000 for selling a product is shown. A description of the product is shown to the user, which may include a graphical image of the product 1010, a title for the product 1020, a price 1030, and action elements 1040 (in this example, add-to-cart, add to baby registry, add to wish list), a summary of user reviews 1050, or the like. FIG. 2 demonstrates the result when the user scrolls down to more items in the page. The action elements 1040 and many of the product descriptions are hidden. In effect, these elements disappear off the top of the page as the user scrolls the page down.

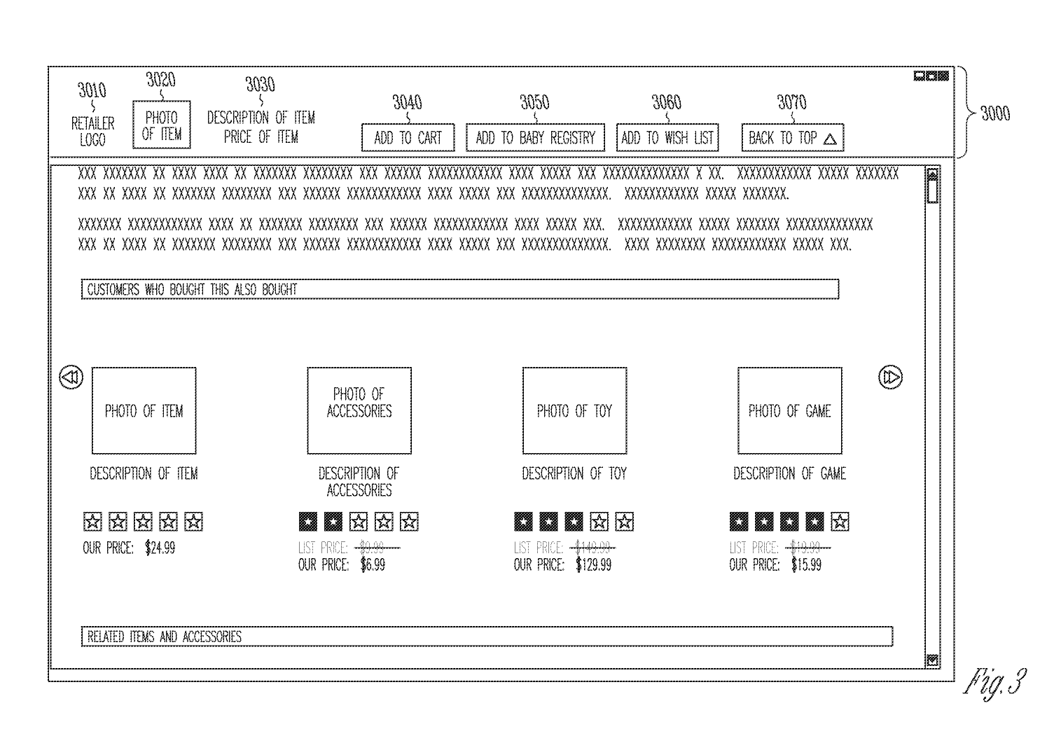

Turning now to FIG. 3 an example of the information and action bar 3000 is shown. In some examples, once the user scrolls past the “add-to-cart” button, the information and action bar may be displayed. In some examples the information and action bar may overlay over the web page. The overlay location may include the top, bottom, left, right, or any other location. The information and action bar 3000 may have one or more graphic elements which make the information and action bar 3000 to appear to be floating over the web page. In the example of FIG. 3, the information and action bar 3000 is overlaid on top of the actual description and includes a drop-shadow to give the appearance of depth.

The information and action bar 3000 may include (but is not limited to) information, such as a retailer logo 3010, a graphic 3020, the item title 3030 (and price). The information and action bar may also include action items such as an add-to-cart button 3040, an add-to-baby-registry button 3050, an add-to-wish-list button 3060, and a navigation button such as a back to the top of the page button 3070. Other action items and information items may be displayed. For example, an “average customer review” of the product, a short description, social media widgets, or the like may be displayed.

In some examples, the information and action bar 3000 does not display until a predetermined trigger point is reached by the consumer in the web-page. For example, when one or more action elements in the main web-page is scrolled past by the user (e.g., no longer visible). In some examples, the one or more action elements scrolled past may have associated action elements in the information and action bar 3000 which may enable a retailer to ensure that these action elements are constantly present on the screen. It should be noted, that the action elements on the information and action bar 3000 are different than the action elements on the main web page. The information and action bar is not simply the action elements moving with the scrolling of the user, but is a new user interface element introduced upon the consumer scrolling past a predefined trigger point. However, as already noted, triggering an action element on the information and action bar may trigger the action element on the web-page through a script which may simulate actions on the web-page.

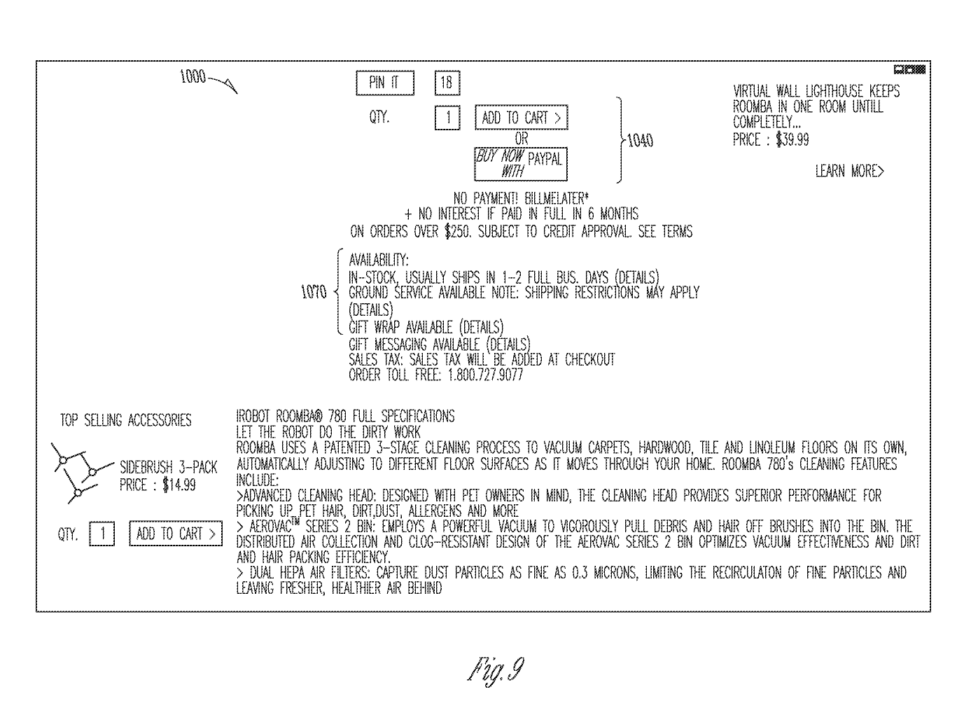

Turning now to FIG. 8, an example web-page 1000 for selling a product is shown. A description of the product is shown to the user, which may include a graphical image of the product 1010, a title for the product 1020, a price 1030, and action elements 1040 (in this example, add-to-cart, and a PayPal action element), a summary of user reviews 1050, or the like. An upper portion of a webpage is visible in this view, and the action elements 1040 are visible adjacent a lower edge of the viewed page.

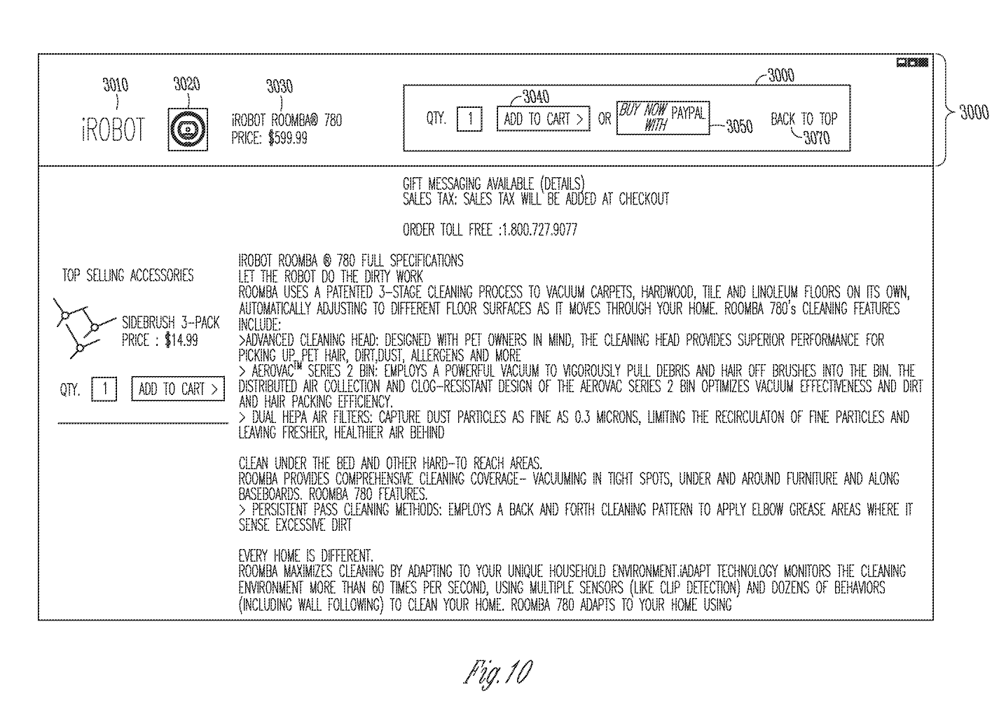

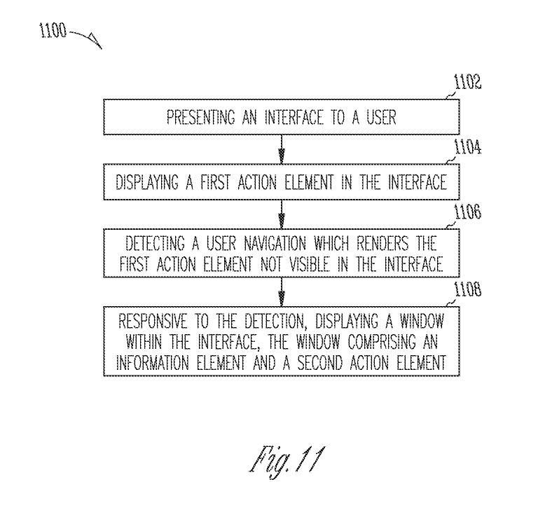

FIG. 9 demonstrates the result when the user scrolls down to more items in the page. The action elements 1040 are still visible, but now lie adjacent an upper edge of the viewed page. Website content that is contained in a lower portion of the web page, or in a subsequent page in a page sequence, is now visible underneath the action elements 1040. As the user scrolls further down the page (or onto a subsequent page) the action elements 1040 “disappear” off the top of the viewed page and are no longer visible. An information and action bar 3000 descends from the top of the page and becomes visible as shown in FIG. 10. The first action elements 1040 shown in FIG. 8 are in this sense “replaced” by the second action elements 3040 and 3050 displayed in the information and action bar appearing in the web page of FIG. 10. The disappearance of the first action elements may be caused by the user performing a navigation such as a scrolling action, a screen resizing, or a zoom action, for example. Other types of user navigation are possible.

Turning now to FIG. 10 an example of the information and action bar 3000 is shown. In some examples, once the user scrolls past the “add-to-cart” or the “PayPal” button, the information and action bar 3000 is displayed. In some examples the information and action bar may overlay over the web page. The overlay location may include the top, bottom, left, right, or any other location of the web page. The information and action bar 3000 may have one or more graphic elements which make the information and action bar 3000 to appear to be floating over the web page. In the example of FIG. 10, the information and action bar 3000 is overlaid on top of some product availability information (visible at 1070 in FIG. 9) and can include a drop-shadow to give the appearance of depth. Further information contained in lower portions of the page (or on a subsequent page) appears further below the information and action bar.

The information and action bar 3000 may include (but is not limited to) information, such as a retailer logo 3010, a graphic 3020, the item title 3030 and price. The information and action bar may also include action items such as an add-to-cart button 3040, and a PayPal button 3050. Other navigation buttons such as a back to the top of the page button 3070 are possible. Other action items and information items may be displayed. For example, average customer reviews of the product, a short description, social media widgets, or the like.

If a user scrolls back up the web page, the information and action bar 3000 containing the second action elements “disappears” off the top of the screen and is once again “replaced” by the appearance of the first action elements 1040. In this way, commercially important action elements such as “add-to-cart” and/or payment actions (such as PayPal) are kept visible and operational as other web site content is reviewed by a user.

In some examples, the information and action bar 3000 does not display until a predetermined trigger point is reached by the consumer in the web-page. For example, when one or more action elements in the main web-page is scrolled past by the user (e.g., no longer visible). In some examples, the one or more action elements scrolled past may have associated action elements in the information and action bar 3000 which may enable a retailer to ensure that these action elements are constantly present on the screen. It should be noted, that the action elements on the information and action bar 3000 can be the same or different than the action elements on the main web page. The information and action bar is not simply the action elements moving with the scrolling of the user, but can be a new user interface element introduced upon the consumer scrolling past a predefined trigger point. However, as already noted, triggering an action element on the information and action bar may trigger the action element on the web-page through a script which may simulate actions on the web-page.

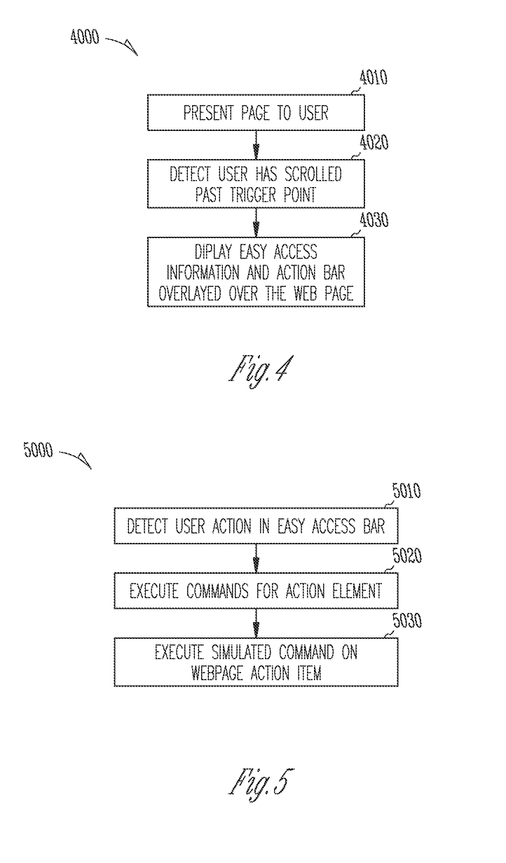

Turning now to FIG. 4, a method of displaying an information and action bar 4000 is shown. At operation 4010 the user may navigate to the merchant's item page where it will be presented to the user. The browser may detect that the user has scrolled past, or to, a predetermined trigger point at operation 4020. Once the user has scrolled past, or to, the predetermined trigger point, the browser may display the information and action bar at operation 4030.

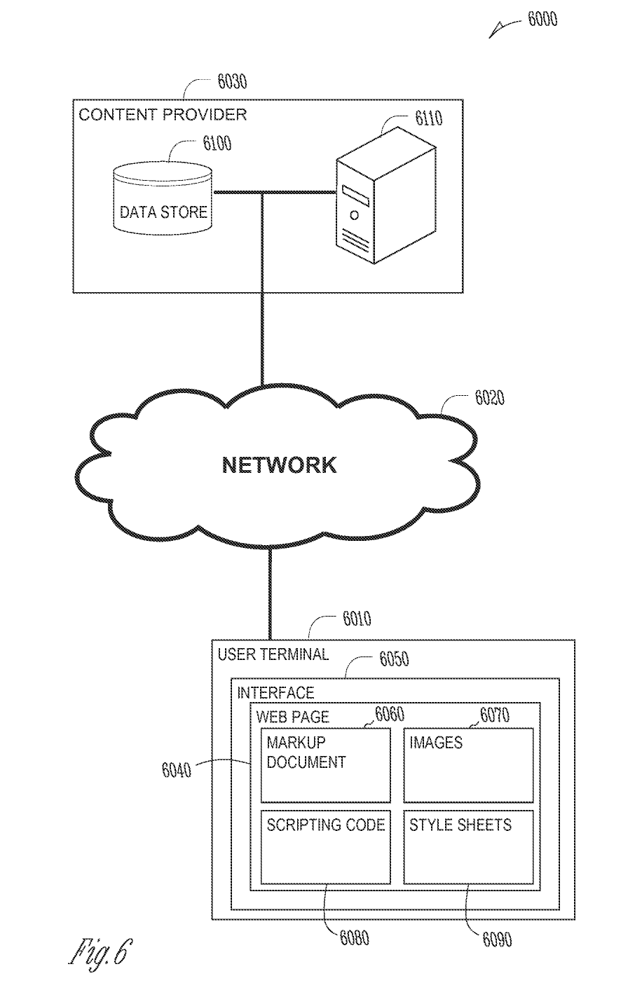

Turning now to FIG. 5, at operation 5010, the browser detects a user action associated with one of the action elements of the information and action bar. User actions may include clicking on an action element, positioning a navigation pointer (e.g., a mouse cursor/pointer) over an action element, entering text, a keyboard shortcut, or the like. At operation 5020, the system may execute scripting or other commands associated with the action element. In some examples, at operation 5030, the scripting commands may include triggering the execution of the action element of the site. For example, rather than creating duplicate action items, one for the web-page, and another for the information and action bar, triggering an action element in the information and action bar may execute a script (e.g., JavaScript) which may simulate a click event or other action on the action element in the main web-page. Thus the user's click or other action which triggers an action element on the information and action bar may be “tunneled” or linked to an associated action element on the main web page. This may allow for an easier implementation as certain action items may need to trigger a lot of differing operations (e.g., an add-to-cart action may trigger a number of different operations), some of which may or may not be clear from the source code of the web-page. Creating a script which “tunnels” or simulates the user action to the action element of the web-page ensures that all required actions associated with the action element of the main page are executed. Additionally, this allows for a more efficient code base as fewer code modules need to be duplicated. In other examples, the actions carried out by the action item of the information and action bar may be independent of the actions of any associated action items on the web-page. An associated action item may be defined as an action item on the information and action bar which has a functional counterpart on the web-page itself.

Turning now to FIG. 11, an example method 1100 is shown. The method comprises: at 1102, presenting an interface to a user; at 1104, displaying a first action element in the interface; at 1106, detecting a user navigation which renders the first action element not visible in the interface; at 1108, responsive to the detection, displaying a window within the interface, the window comprising an information element and a second action element.

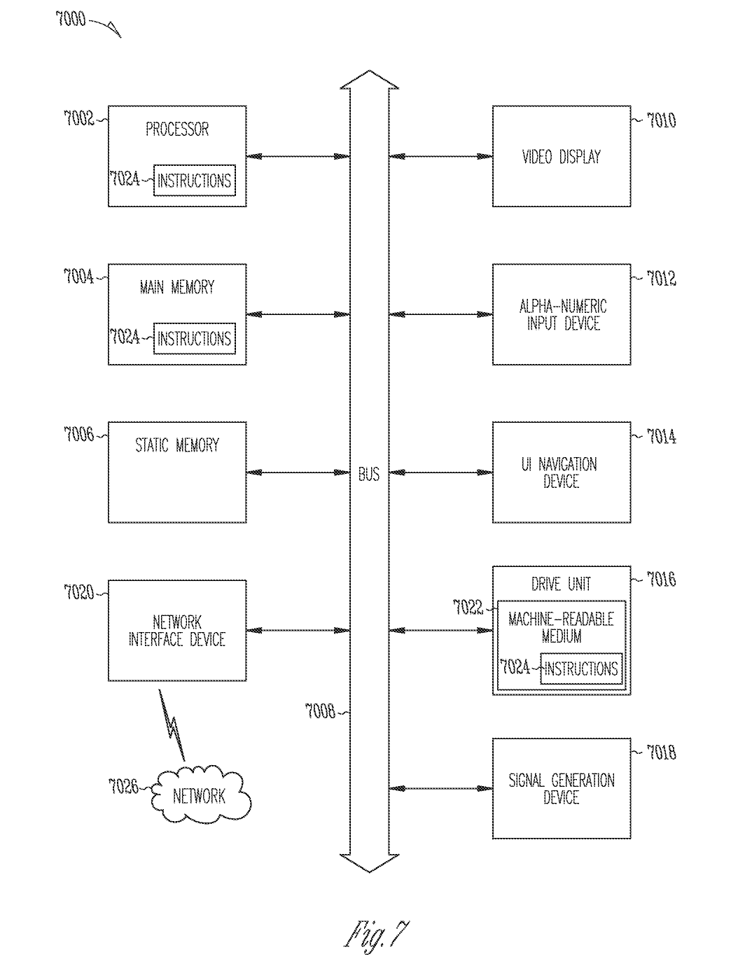

Turning now to FIG. 6, an example system 6000 is shown. User terminal 6010 may be used by a user to access web-pages across a network 6020. User terminal 6010 may be any user device capable of communicating with a content provider 6030 across a network 6020 and downloading and displaying web pages 6040 in a browser 6050 (or other program). Example user terminals include desktop computers, server computers, tablet computers (e.g., an IPAD manufactured by Apple Computer of Cupertino, Calif.), smartphones (e.g., smartphones running the DROID® operating system developed by GOOGLE, Inc., of Mountain View, Calif., or smartphones such as the iPhone®, manufactured by Apple Computer), cell phones, or other devices. Network 6020 may include any network which may connect user terminal 6010 and content provider 6030 and may include or be any portion of one or more of a Wide Area Network (WAN), Local Area Network (LAN), the Internet, a cellular network (e.g., a cellular network operating according to a Universal Mobile Telecommunications (UMTS) family of standards, or a Long Term Evolution (LTE) family of standards), or the like. Web page 6040 is interpreted and displayed by browser 6050 and may include one or more markup language documents 6060 including HyperText Markup Language (HTML), eXtensible Markup Language (XML), or the like. Web page 6040 may also include one or more images 6070. Images 6070 may be digitally represented in any browser renderable format, Web page 6040 may also include one or more scripting modules 6080 for causing the browser 6040 to perform various actions. Scripting modules 6080 may be JavaScript modules, PHP modules, or the like. In some examples, scripting modules 6080 may include code which when executed by the user terminal 6010 may cause the information and action bar to display at the appropriate time. Web page 6040 may include one or more style sheets 6080, such as Cascading Style Sheets (CSS).

Content provider 6030 may include one or more data stores 6100 for storing content, such as web page 6040 for delivery to one or more user terminals 6010 upon request from user terminal 6010. Content provider 6030 may also include one or more servers 6110 for communicating with the user terminals 6010 over network 6020 and for causing content stored in the data store 6100 to be delivered to one or more user terminals 6010.

In some examples, the information and action bar may appear different to user's viewing the web-page on a mobile device. For example, the content provider 6030 may detect that user terminal 6010 is a mobile device such as a smartphone. In response to detecting that the user terminal 6010 is a smartphone, the content server may provide an alternative information and action bar through a different scripting module 6080. In other examples, the executable code which displays the information and action bar may detect that it is running on a mobile device. The mobile-enhanced information and action bar may be a simpler version with content tailored to a mobile device's more limited screen and user interface. For example, less information and/or less action elements may be displayed. The information and/or action elements may be displayed in a larger size (e.g., for better readability on a small display), a smaller size (e.g., to fit on a smaller display), a different color, a different font, a different font style, or the like.

### Example Machine

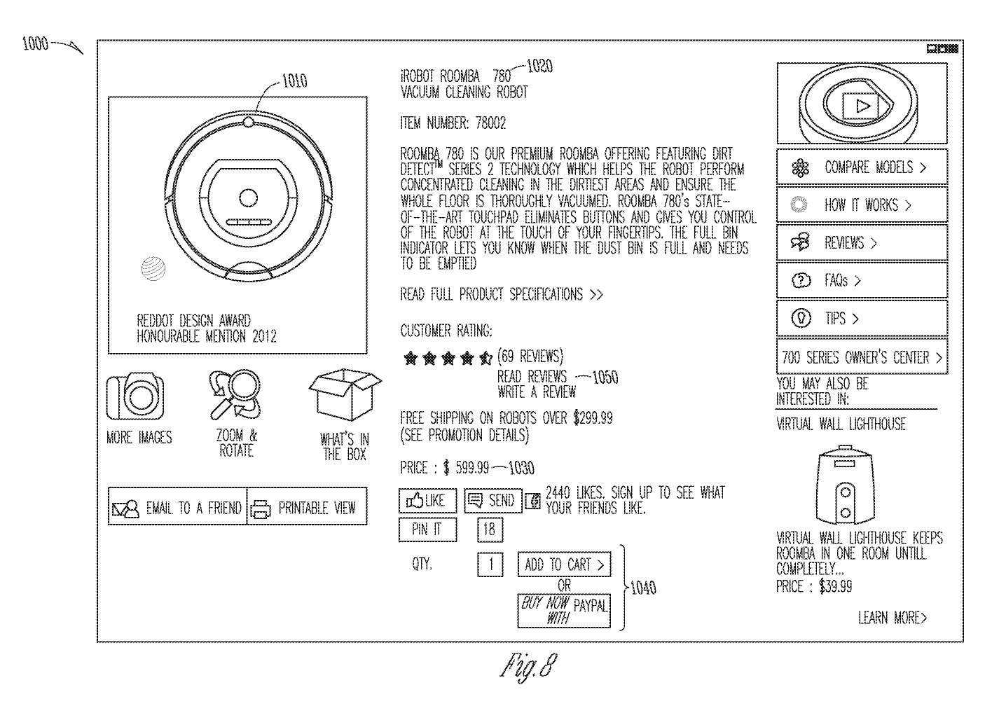

FIG. 7 illustrates a block diagram of an example machine 7000 upon which any one or more of the techniques (e.g., methodologies) discussed herein can be performed. The user terminal and any components of the content provider 6030 may be or include one or more components of machine 7000. In various embodiments, the machine 7000 can operate as a standalone device or can be connected (e.g., networked) to other machines. In a networked deployment, the machine 7000 can operate in the capacity of a server machine, a client machine, or both in server-client network environments. In an example, the machine 7000 can act as a peer machine in peer-to-peer (P2P) (or other distributed) network environment. The machine 7000 can be a personal computer (PC), a tablet PC, a set-top box (STB), a Personal Digital Assistant (PDA), a mobile telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. For example, the functions of the machine 7000 can be distributed across multiple other machines in a network.

Examples, as described herein, can include, or can operate on, logic or a number of components, modules, or mechanisms. Modules are tangible entities capable of performing specified operations and can be configured or arranged in a certain manner. In an example, circuits can be arranged (e.g., internally or with respect to external entities such as other circuits) in a specified manner as a module. In an example, the whole or part of one or more computer systems (e.g., a standalone, client or server computer system) or one or more hardware processors can be configured by firmware or software (e.g., instructions, an application portion, or an application) as a module that operates to perform specified operations. In an example, the software can reside (1) on a non-transitory machine-readable medium or (2) in a transmission signal. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor can be configured as one or more modules that can change over time. Software can accordingly configure a hardware processor, for example, to constitute a particular module at one instance of time and to constitute a different module at a different instance of time. Or to constitute one or more modules at the same time.

Machine (e.g., computer system) 7000 can include a hardware processor 7002 (e.g., a central processing unit (CPU), a graphics processing unit (GPU), a hardware processor core, or any combination thereof), a main memory 7004 and a static memory 7006, some or all of which can communicate with each other via a bus 7008. The machine 7000 can further include a display unit 7010, an alphanumeric input device 7012 (e.g., a keyboard), and a user interface (UI) navigation device 7011 (e.g., a mouse). In an example, the display unit 7010, input device 7017 and UI navigation device 7014 can be a touch screen display. The machine 7000 can additionally include a storage device (e.g., drive unit) 7016, a signal generation device 7018 (e.g., a speaker), a network interface device 7020, and one or more sensors 7021, such as a global positioning system (GPS) sensor, compass, accelerometer, or other sensor. The machine 7000 can include an output controller 7028, such as a serial (e.g., universal serial bus (USB), parallel, or other wired or wireless (e.g., infrared(IR) connection to communicate or control one or more peripheral devices (e.g., a printer, card reader, etc.).

The storage device 7016 can include a machine-readable medium 7022 on which is stored one or more sets of data structures or instructions 7024 (e.g., software) embodying or utilized by any one or more of the techniques or functions described herein. The instructions 7024 can also reside, completely or at least partially, within the main memory 7004, within static memory 7006, or within the hardware processor 7002 during execution thereof by the machine 7000. In an example, one or any combination of the hardware processor 7002, the main memory 7004, the static memory 7006, or the storage device 7016 can constitute machine readable media.

While the machine-readable medium 7022 is illustrated as a single medium, the term “machine readable medium” can include a single medium or multiple media (e.g., a centralized or distributed database, and/or associated caches and servers) that configured to store the one or more instructions 7024.

The term “machine-readable medium” can include any tangible medium that is capable of storing, encoding, or carrying instructions for execution by the machine 7000 and that cause the machine 7000 to perform any one or more of the techniques of the present disclosure, or that is capable of storing, encoding or carrying data structures used by or associated with such instructions. Non-limiting machine-readable medium examples can include solid-state memories, and optical and magnetic media. Specific examples of machine-readable media can include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 7024 can further be transmitted or received over a communications network 7026 using a transmission medium via the network interface device 7020. Network interface device 7020 may connect the machine 7000 to a network of other machines in order to communicate with the other machines in the network by utilizing any one of a number of transfer protocols (e.g., frame relay, internet protocol (IP), transmission control protocol (TCP), user datagram protocol (UDP), hypertext transfer protocol (HTTP), etc.). Example communication networks can include a local area network (LAN), a wide area network (WAN), a packet data network (e.g., the Internet), mobile telephone networks (e.g., cellular networks) such as a Long Term Evolution (LTE) network, Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), peer-to-peer (P2P) networks, among others. In an example, the network interface device 7020 can include one or more physical jacks (e.g., Ethernet, coaxial, or phone jacks) or one or more antennas to connect to the communications network 7026. In an example, and as shown in FIG. 7, the network interface device 7020 can include a plurality of antennas, to wirelessly communicate using at least one of single-input output (SIMO), multiple-input multiple-output (MIMO), or multiple-input single-output (MISO) techniques. The term “transmission medium” shall be taken to include any intangible medium that is capable of storing, encoding or carrying instructions for execution by the machine 7000, and includes digital or analog communications signals or other intangible medium to facilitate communication of such software.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

### OTHER EXAMPLES

Disclosed in some examples is a method including presenting a web-page to a user; detecting a user navigation of a web page past a predetermined trigger point; displaying a window overlaid over a portion of the web page, the window comprising an information element and an action element; detecting a user action associated with the action element; and performing an action associated with the action element.

Disclosed in other examples is a system including a browser module, executing on one or more computer processors and configured to: present a web-page to a user; detect a user navigation of a web page past a (predetermined trigger point; display a window overlaid over a portion of the web page, the window comprising an information element and an action element; detect a user action associated with the action element; and perform an action associated with the action element.

Disclosed in yet other examples is a machine readable medium, including instructions, which when performed by a machine, causes the machine to perform the operations of: presenting a web-page to a user; detecting a user navigation of a web page past a predetermined trigger point; displaying a window overlaid over a portion of the web page, the window comprising an information element and an action element; detecting a user action associated with the action element; and performing an action associated with the action element.

These examples can be combined in any permutation or combination. This overview is intended to provide an overview of subject matter of the present patent application. It is not intended to provide an exclusive or exhaustive explanation of the invention. The detailed description is included to provide further information about the present patent application.

1. A method comprising:
presenting an interface to a user;
displaying a first action element in the interface;
detecting a user navigation which moves the first action element and renders the first action element not visible in the interface; and
responsive to the detection, displaying a window within the interface, the window comprising an information element and a second action element.

2. The method of claim 1, wherein detecting a user navigation includes detecting a user navigation past a predetermined trigger point in the interface.

3. The method of claim 1, wherein detecting a user navigation includes detecting a scrolling or resizing action in the interface by the user.

4. The method of claim 1, wherein the displayed window is overlaid over a portion of the interface.

5. The method of claim 1, further comprising:
detecting a user action associated with the first or second action element; and
performing an action associated with the first or second action element.

6. The method of claim 5, wherein the action associated with the first or second action element includes executing a script.

7. The method of claim 6, wherein the script simulates a user action associated with the second or first action element, respectively.

8. The method of claim 1, wherein the first and second action elements relate to the same action.

9. The method of claim 5, wherein the first and second action elements function independently of each other in performing the action.

10. The method of claim 5, wherein performing the action associated with the first or the second action element includes executing the same script, irrespective of whether the action is associated with either the first or the second action element.

11. The method of claim 1, wherein the displayed window remains displayed regardless of where the user navigates in the interface until the user effects a navigation causing the first action element to be rendered visible in the interface again.

12. A system comprising:
at least one module, executing on one or more computer processors, to:
present an interface to a user;
display a first action element in the interface;
detect a user navigation which moves the first action element and renders the first action element not visible in the interface; and
responsive to the detection, display a window within the interface, the window comprising an information element and a second action element.

13. The system of claim 12, wherein detecting a user navigation includes detecting a user navigation past a predetermined trigger point in the interface.

14. The system of claim 12, wherein detecting a user navigation includes detecting a scrolling or resizing action in the interface by the user.

15. The system of claim 12, wherein the displayed window is overlaid over a portion of the interface.

16. The system of claim 12, wherein the at least one module is further to:
detect a user action associated with the first or second action element; and
perform an action associated with the first or second action element.

17. The system of claim 16, wherein the action associated with the first or second action element includes executing a script.

18. The system of claim 17, wherein the script simulates a user action associated with the second or first action element, respectively.

19. The system of claim 12, wherein the first and second action elements relate to the same action.

20. The system of claim 16, wherein the first and second action elements function independently of each other in performing the action.

21. The system of claim 16, wherein performing the action associated with the first or the second action element includes executing the same script, irrespective of whether the action is associated with either the first or the second action element.

22. The system of claim 12, wherein the displayed window is to remain displayed regardless of where the user navigates in the interface until the user effects a navigation causing the first action element to be rendered visible in the interface again.

23. A non-transitory machine readable medium, including instructions, which when performed by a machine, causes the machine to perform the operations of:
presenting an interface to a user;
displaying a first action element in the interface;
detecting a user navigation which moves the first action element and renders the first action element not visible in the interface; and
responsive to the detection, displaying a window within the interface, the window comprising an information element and a second action element.

24. The medium of claim 23, wherein detecting a user navigation includes detecting a user navigation past a predetermined trigger point in the interface.

25. The medium of claim 23, wherein detecting a user navigation includes detecting a scrolling or resizing action in the interface by the user.

26. The medium of claim 23, wherein the displayed window is overlaid over a portion of the interface.

27. The medium of claim 23, wherein the operations further comprise:
detecting a user action associated with the first or second action element; and
performing an action associated with the first or second action element.

28. The medium of claim 27, wherein the action associated with the first or second action element includes executing a script.

29. The medium of claim 28, wherein the script simulates a user action associated with the second or first action element, respectively.

30. The medium of claim 23, wherein the first and second action elements relate to the same action.

31-33. (canceled)
